(19) United States
(12) Patent Application Publication
(10) Pub. No.: US 2025/0303969 A1
(43) Pub. Date: Oct. 2, 2025

(54) VEHICLE BODY FRONT STRUCTURE

(71) Applicant: SUBARU CORPORATION, Tokyo (JP)

(72) Inventor: Akihiro MAEDA, Tokyo (JP)

(21) Appl. No.: 19/042,839

(22) Filed: Jan. 31, 2025

(30) Foreign Application Priority Data
Mar. 29, 2024 (JP) 2024-055464

(51) Int. Cl. B60R 5/02; B62D 25/08

(52) U.S. Cl. CPC B60R 5/02; B62D 25/085

(57) ABSTRACT

A vehicle body front structure includes: front side frames in a pair on left and right sides of a vehicle body front portion; a structural body on a front side of the vehicle body front portion; a high-voltage component on a rear side of the vehicle body front portion; and a front trunk attached to a front space between the structural body and the high-voltage component. Both ends of a cross member having an upper surface that come into contact with a lower surface of the front trunk are fixed to the front side frames. A trunk-side inclined surface inclined upward from the vehicle body front portion to a rear portion is formed on the lower surface of the front trunk. A support inclined surface that comes into contact with the trunk-side inclined surface to support the front trunk is provided on the upper surface of the cross member.

### CROSS-REFERENCE TO RELATED APPLICATIONS

The present application claims priority from Japanese Patent Application No. 2024-055464 filed on Mar. 29, 2024, the entire contents of which are hereby incorporated by reference.

### BACKGROUND

The disclosure relates to a vehicle body front structure.

In recent electric vehicles, a motor is disposed on a drive shaft side, so that a space with a relatively large capacity is created below a front hood. A technique of effectively utilizing this space as a front trunk (also referred to as a “frunk”) is known.

For example, Japanese Unexamined Patent Application Publication (JP-A) No. 2010-58737 discloses a technique of disposing a front trunk (baggage compartment box) in a region surrounded by front side frames disposed on left and right sides of a vehicle body front portion, a bumper beam disposed on a front portion, and a toe board disposed on a rear portion.

Also, in JP-A No. 2010-58737, a radiator and an air conditioner unit are disposed on a rear portion of the front trunk. A bead is formed on a bottom of the front trunk. The front trunk supports the bumper beam at the bead from a vehicle body rear portion.

In JP-A No. 2010-58737, when a vehicle undergoes a frontal collision, an impact load at that time is transmitted to the front side frames and the front trunk via the bumper beam. A part of the impact load transmitted to the front trunk is absorbed by crushing the bead, and is distributed to the left and right front side frames. As a result, the impact load during the frontal collision is distributed between the front side frames and the bead of the front trunk.

### SUMMARY

An aspect of the disclosure provides a vehicle body front structure for a vehicle. The vehicle body front structure includes front side frames in a pair, a structural body, a high-voltage component, and a front trunk. The front side frames are respectively disposed on left and right sides of a vehicle body front portion of the vehicle in a vehicle width direction of the vehicle. The structural body has a rigidity disposed on a front side of the vehicle body front portion. The high-voltage component is disposed on a rear side of the vehicle body front portion. The front trunk is attached to a front space between the structural body structural body structural body structural body structural body and the high-voltage component. Both ends of a cross member are fixed to the pair of front side frames respectively. The cross member extends on the left and right sides in the vehicle width direction and having an upper surface configured to come into contact with a lower surface of the front trunk. The trunk-side inclined surface is provided on the lower surface of the front trunk, and inclined upward from the vehicle body front portion to a rear portion of the vehicle. The support inclined is provided on the upper surface of the cross member surface and configured to come into contact with the trunk-side inclined surface to support the front trunk.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic cross-sectional side view illustrating a vehicle body front structure.

FIG. 2 is a schematic cross-sectional side view of the vehicle body front structure illustrating a state in which a front trunk moves due to a frontal collision.

FIG. 3 is a schematic cross-sectional side view of the vehicle body front structure illustrating a state in which the front trunk is raised due to a frontal collision.

FIG. 4A is a schematic plan view of the vehicle body front structure.

FIG. 4B is a schematic plan view of the vehicle body front structure in a state in which the front trunk is attached.

FIG. 5 is an enlarged view of a portion V of FIG. 4B.

FIG. 6A is a cross-sectional side view illustrating the front trunk fixed to a vehicle body front portion.

FIG. 6B is a cross-sectional side view illustrating a state in which the front trunk is pressed by a frame-shaped structural body due to a frontal collision.

FIG. 6C is a cross-sectional side view illustrating a state in which the front trunk is latched to a hook of a front hood.

### DETAILED DESCRIPTION

A front trunk may accommodate structures having a high rigidity, such as golf sets and tools. In a state in which a structure having a high rigidity is accommodated in the front trunk, the front trunk tends to become pseudo-rigid.

If the front trunk becomes pseudo-rigid by contents, the front trunk becomes less likely to be deformed and crushed even when a vehicle undergoes a frontal collision, and the impact load is transmitted to the front trunk. As a result, the front trunk becomes an obstacle and a crushing stroke may not be ensured, and it is difficult to obtain favorable energy absorber (EA) characteristics.

In the technique disclosed in JP-A No. 2010-58737 as described above, the distribution of the impact load by the front trunk during a frontal collision largely depends on the contents accommodated therein.

It is desirable to provide a vehicle body front structure capable of efficiently absorbing an impact load during a frontal collision even in the state in which contents are accommodated in the front trunk.

Hereinafter, an embodiment of the disclosure will be described based on the drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

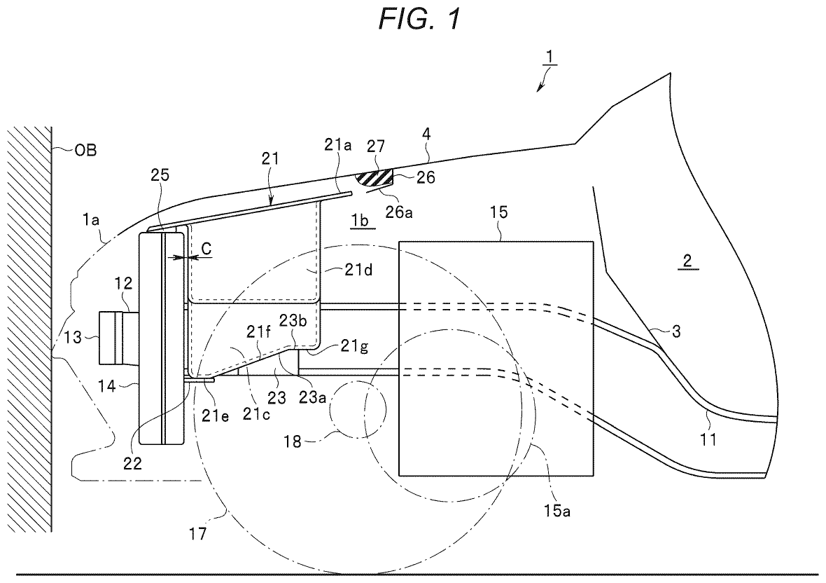

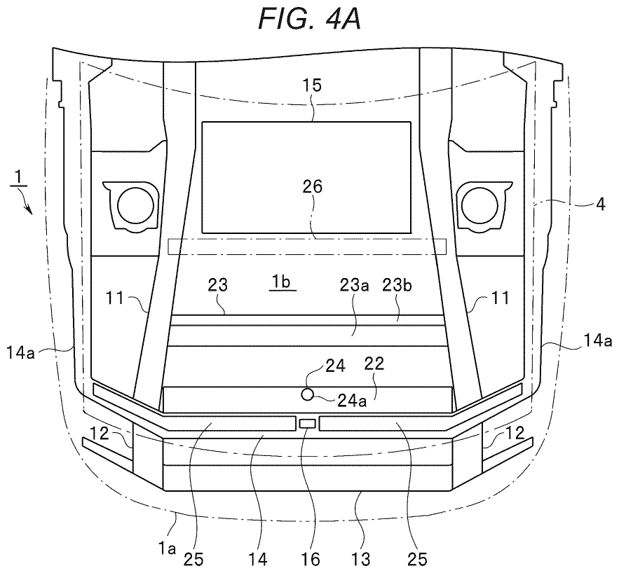

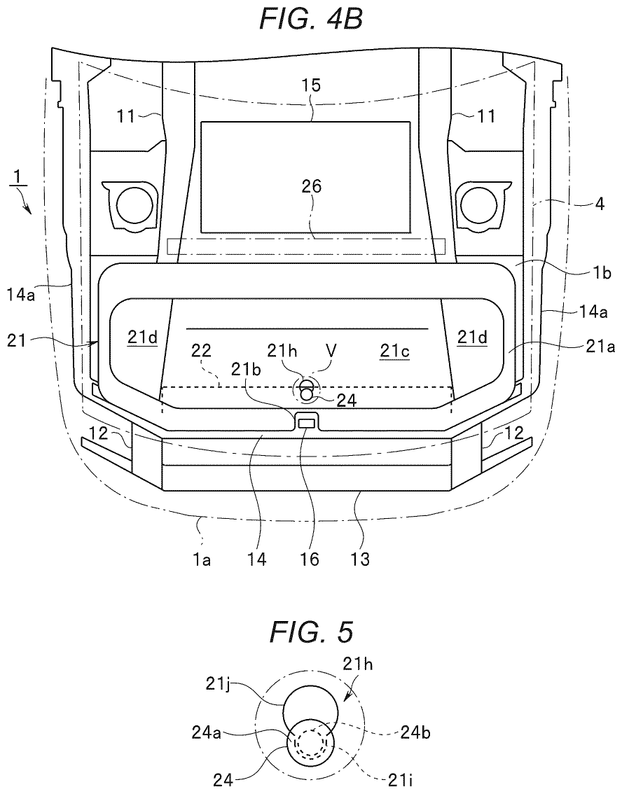

As illustrated in FIGS. 1 and 4, a vehicle body front portion 1 is partitioned by a vehicle cabin 2 in which an occupant sits and a toe board 3. An upper portion of the vehicle body front portion 1 is covered with a front hood 4. A rear portion of the front hood 4 is supported on a vehicle body via a hinge (not illustrated), and a front portion of the front hood 4 is openable and closable.

Also, a pair of front side frames 11 extending in a front-rear direction of the vehicle body are provided on the vehicle body front portion 1 on left and right sides in a vehicle width direction. The front side frame 11 is a vehicle body frame member, and has a substantially rectangular shape in cross-section along the width direction of the vehicle body.

A lower portion of the toe board 3 that partitions the vehicle body front portion 1 and the vehicle cabin 2 is inclined obliquely rearward, and is continuous with a front portion of a floor panel (not illustrated) that forms a floor of the vehicle cabin 2. A rear portion of the front side frame 11 extends downward along the toe board 3. Also, a rear end of the front side frame 11 is joined to a front portion of a bottom surface of the floor panel.

Further, rear ends of crash boxes 12 are joined to front ends of the front side frames 11. Tip ends of the left and right crash box 12 are joined and coupled to both ends of a bumper beam 13 extending in the vehicle width direction. A front surface of the bumper beam 13 is covered with a bumper face 1a.

When a front end of the vehicle body front portion 1 collides, the crash box 12 is crushed to absorb a part of an impact. The bumper beam 13 has a substantially rectangular shape in cross-section along the front-rear direction of the vehicle body. Ends of the bumper beam 13 in the vehicle width direction are inclined toward a rear side of the vehicle body.

Also, a frame-shaped structural body 14 having a high rigidity confronts a rear side of the bumper beam 13. The frame-shaped structural body 14 is, for example, a radiator panel. When the frame-shaped structural body 14 is a radiator panel, the radiator panel supports a radiator core for cooling a high-voltage component 15 to be described later, a condenser of an air conditioner, and the like.

A main body of the frame-shaped structural body 14 is disposed between the left and right front side frames 11. Frames 14a extending toward the rear side of the vehicle body are permanently affixed to upper and lower ends of the main body in the vehicle width direction. The frames 14a are joined to the left and right front side frames 11 via brackets (not illustrated).

Also, a hood lock mechanism 16 is fixed to a center of an upper surface of the frame-shaped structural body 14 in the vehicle width direction. A striker (not illustrated) is fixed to inside of a front portion of the front hood 4 at the center in the vehicle width direction. In a state in which the front hood 4 covers the vehicle body front portion 1, the striker is engaged with a hook provided on the hood lock mechanism 16. When the striker is engaged with the hook, the front portion of the front hood 4 is locked to the vehicle body front portion 1.

Also, the high-voltage component 15 is disposed between the left and right front side frames 11 on a toe board 3 side of the vehicle body front portion 1. The high-voltage component 15 is placed on and fixed to a sub-frame such as a suspension cross member (not illustrated). Both ends of the sub-frame are fixed to the front side frames 11.

The high-voltage component 15 includes a traveling motor 15a, a power control unit (PCU) that controls power to be supplied to the traveling motor 15a, and the like. The traveling motor 15a is disposed at a position close to a drive shaft 18 of front wheels 17. In order to prevent damage caused by receiving an impact load during a frontal collision, the high-voltage component 15 is disposed at a position distant from a front end of the vehicle body, that is, on the toe board 3 side.

Also, as illustrated in FIG. 4A, a front space 1b is formed between the frame-shaped structural body 14 of the vehicle body front portion 1 and the high-voltage component 15. As illustrated in FIG. 4B, a front trunk 21 is disposed in the front space 1b. The front trunk 21 is a one-piece molded product made of a resin or an aluminum alloy. The front trunk 21 has a box shape with an opened upper surface. A flange 21a is formed on a peripheral edge of the upper surface of the front trunk 21.

A front portion of the flange 21a is placed on the frame-shaped structural body 14. A notch 21b for avoiding interference with the hood lock mechanism 16 is formed in a center of the flange 21a on a front portion in the vehicle width direction. A lid body that opens and closes an opening may be attached to the upper surface of the front trunk 21.

Also, a deep center accommodation member 21c is formed in a center of the front trunk 21. Further, side portion accommodation members 21d shallower than the center accommodation member 21c are formed on left and right sides of the front trunk 21 in the vehicle width direction. Further, a lower surface front portion of the center accommodation member 21c serves as a front flat surface 21e. Also, a lower surface of the center accommodation member 21c has an inclined surface (trunk-side inclined surface) 21f that is inclined obliquely upward and continuous with a rear portion of the front flat surface 21e. Further, a rear flat surface 21g continuous with the trunk-side inclined surface 21f is formed on a rear portion of the lower surface of the center accommodation member 21c.

The front flat surface 21e of the center accommodation member 21c is placed on a support frame 22. A front end of the support frame 22 is fixed to a rear surface of the frame-shaped structural body 14. The support frame 22 extends rearward from the rear surface of the frame-shaped structural body 14. The support frame 22 has a laterally elongated shape that supports substantially the entire front flat surface 21e in the vehicle width direction. Also, lower surfaces of the left and right side portion accommodation members 21d are placed on upper surfaces of the front side frames 11.

Also, both ends of a cross member 23 in the vehicle width direction are joined to facing surfaces of the front side frames 11. The cross member 23 supports a weight when contents are accommodated in the front trunk 21. Also, the front trunk 21 distributes an impact load during an offset collision of the vehicle body front portion 1 to the front side frames 11 on a non-collision side. The front trunk 21 is, for example, an extruded molded product made of an aluminum alloy or steel, or a molded product obtained by forming a steel plate into a hat shape in cross-section. When the cross member 23 is formed to have a hat shape in cross-section, a lower surface is opened.

A support inclined surface 23a inclined upward from a front end to a rear end is formed on an upper surface of the cross member 23. Further, a flat surface 23b continuous with the support inclined surface 23a is formed at a rear end on the upper surface of the cross member 23. The trunk-side inclined surface 21f formed on a lower surface of the front trunk 21 is placed on the support inclined surface 23a. Also, the rear flat surface 21g formed on the lower surface of the front trunk 21 is placed on the flat surface 23b. When the front trunk 21 is pressed from a front surface, the trunk-side inclined surface 21f of the front trunk 21 moves along the support inclined surface 23a of the cross member 23. This movement causes the front trunk 21 to move obliquely upward and toward the rear side of the vehicle body.

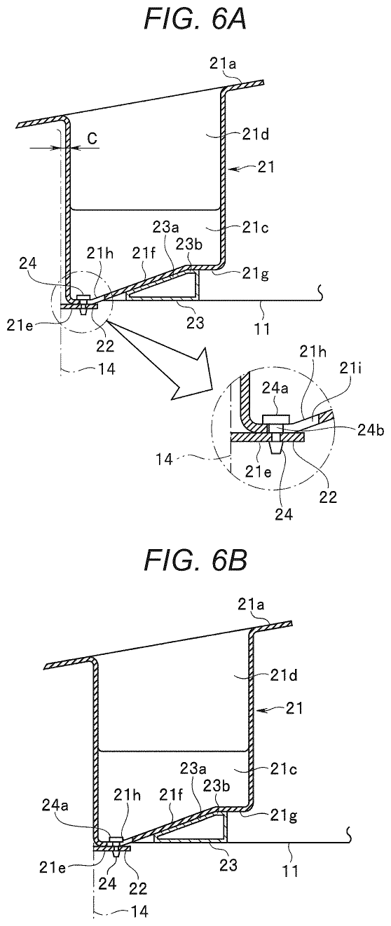

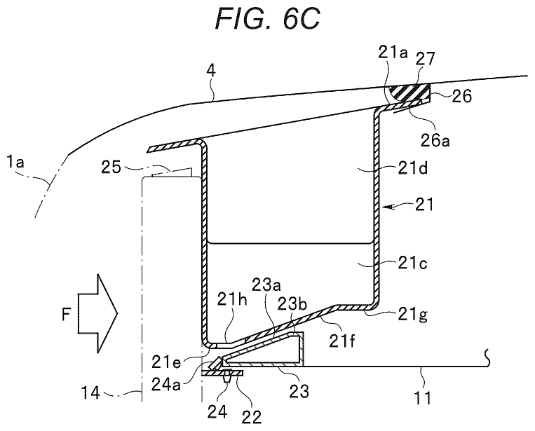

As illustrated in FIGS. 4B and 6A, a clip 24 as a locking member is mounted and fixed to an upper surface of the support frame 22 at the center in the vehicle width direction. The clip 24 is a stepped clip. The clip 24 is made of, for example, a resin.

The clip 24 includes a flat head 24a and a body 24b having a diameter smaller than that of the head 24a. The body 24b is latched on the support frame 22. A length of the body 24b is set to a value equal to or slightly longer than a plate thickness of a bottom of the front trunk 21.

Also, an engaging hole 21h is formed in the front flat surface 21e of the front trunk 21. The engaging hole 21h is formed in a center of the front flat surface 21e in the width direction. The engaging hole 21h is a potbelly hole. The engaging hole 21h has a small-diameter long hole 21i of the potbelly hole that is formed in a front end side, and a large diameter hole 21j continuous with the long hole 21i is formed on a rear side of the long hole 21i. A width of the long hole 21i is slightly larger than the diameter of the body 24b of the clip 24. Also, a diameter of the large diameter hole 21j is larger than that of the head 24a formed on the clip 24.

FIG. 6A illustrates a state in which the long hole 21i of the engaging hole 21h of the front trunk 21 is engaged with the clip 24. In this state, the body 24b of the clip 24 is inserted into the long hole 21i of the engaging hole 21h, and the head 24a is latched to an inner surface of the front flat surface 21e of the front trunk 21 so as to prevent the front trunk 21 from coming off. Accordingly, the front flat surface 21e of the front trunk 21 is supported and fixed to the support frame 22.

Also, in this state, a slight gap C is provided between the rear surface of the frame-shaped structural body 14 and the front trunk 21 (see FIG. 1). This gap C is a margin width for allowing the large diameter hole 21j of the engaging hole 21h to be moved to the head 24a of the clip 24. A performer who wishes to remove the front trunk 21 from the front space 1b pulls the front trunk 21 toward a front side of the vehicle body. Then, the front surface of the front trunk 21 comes into contact with the rear surface of the frame-shaped structural body 14. When the front surface of the front trunk 21 comes into contact with the rear surface of the frame-shaped structural body 14, the head 24a of the clip 24 faces the large diameter hole 21j of the engaging hole 21h. When the performer raises the front trunk 21, the head 24a of the clip 24 comes off from the large diameter hole 21j of the engaging hole 21h. Therefore, the performer can easily remove the front trunk 21 from the front space 1b.

Also, when the vehicle body front portion 1 collides with an obstacle OB, the front surface of the front trunk 21 is pressed against the rear surface of the frame-shaped structural body 14, so that the large diameter hole 21j of the engaging hole 21h faces below the head 24a of the clip 24.

Also, as illustrated in FIG. 1, in a state in which the front trunk 21 is disposed in the front space 1b, the flange 21a faces a back surface of the front hood 4 in a substantially parallel manner. The front hood 4 is inclined rearward and obliquely upward from a vehicle body front end. Therefore, the flange 21a of the front trunk 21 is also inclined rearward and obliquely upward from the vehicle body front end.

A bracket 25 is fixed to the upper surface of the frame-shaped structural body 14 on which a front portion of the flange 21a is placed. The bracket 25 fills a gap between the upper surface of the frame-shaped structural body 14 and the inclined front portion of the flange 21a. Therefore, the bracket 25 may be formed together with the flange 21a on the front portion. As illustrated in FIG. 1, the bracket 25 has a symmetrical shape on the left and right sides in the vehicle width direction with the hood lock mechanism 16 interposed therebetween.

Also, as illustrated in FIGS. 1 and 4A, a flange receiving member 26 is provided on a lower surface of the front hood 4. The flange receiving member 26 includes the L-shaped flange receiving member 26 and an elastic support member 27. The flange receiving member 26 is fixed to the back surface of the front hood 4. The flange receiving member 26 extends in the vehicle width direction in a state substantially parallel to a rear portion of the flange 21a formed on the front trunk 21. The flange receiving member 26 is opened toward the vehicle body front portion, and a claw 26a is formed on a lower portion of the flange receiving member 26.

Further, the elastic support member 27 is attached to the back surface of the front hood 4 facing the claw 26a. The elastic support member 27 is disposed in a belt shape along the claw 26a. The elastic support member 27 is a resilient member made of rubber and the like. A gap between the claw 26a and the elastic support member 27 is the same as or slightly wider than the claw 26a and the flange 21a. Note that a reference numeral OB in FIGS. 1 to 3 denotes the obstacle. Examples of the obstacle OB include a stereoscopic stationary object such as a wall and a utility pole, and a vehicle approaching from ahead.

The claw 26a of the flange receiving member 26 is formed at a position where the claw 26a is inserted under a lower surface of the rear portion of the flange 21a formed on the front trunk 21 when the vehicle body front portion 1 collides with the obstacle OB. That is, when the vehicle body front portion 1 collides with the obstacle OB, the crash box 12 and the front portions of the front side frames 11 are crushed.

This crushing causes the cross member 23 and the front hood 4 to move toward the vehicle body front end. The front trunk 21 moves upward by the movement of the cross member 23. The claw 26a of the flange receiving member 26 is inserted under the lower surface of the rear portion of the flange 21a formed on the front trunk 21 as the front trunk 21 rises. Further, the elastic support member 27 presses the upper surface of the flange 21a. Accordingly, the rear portion of the flange 21a is supported.

Next, effects when the vehicle body front portion 1 having the above configuration has a frontal collision with the obstacle OB will be described.

During traveling, when a tip end of the vehicle body front portion 1 collides with the obstacle OB, the bumper face 1a is crushed, and the bumper beam 13 on the rear side is pressed against the obstacle OB. An impact load F received by the bumper beam 13 is transmitted to the crash boxes 12 fixed to the left and right rear surfaces of the bumper beam 13, and the crash boxes 12 are crushed. When the crash boxes 12 are crushed, the frame-shaped structural body 14 approaches the bumper beam 13.

Further, the impact load F is transmitted from the crash boxes 12 to the front side frames 11, and the front side frames 11 are crushed. Then, the front surface of the front trunk 21 facing the rear surface of the frame-shaped structural body 14 with the gap C therebetween is pressed against the rear surface of the frame-shaped structural body 14.

As illustrated in FIGS. 5 and 6A, in a state before the vehicle body front portion 1 collides with the obstacle OB, the body 24b of the clip 24 is engaged with the long hole 21i of the engaging hole 21h formed in the front flat surface 21e of the front trunk 21. Accordingly, the front flat surface 21e is fixed by being sandwiched between the head 24a of the clip 24 and the support frame 22.

Here, an operation of the front trunk 21 when the front side frames 11 are crushed by the frontal collision will be described based on FIGS. 6A to 6C.

At an early stage of the collision in which tip ends of the front side frames 11 are crushed, the front surface of the front trunk 21 approaches the rear surface of the frame-shaped structural body 14 that is pressed against a rear portion of the bumper beam 13. When the front surface of the front trunk 21 approaches the frame-shaped structural body 14, the front flat surface 21e of the front trunk 21 slides on the support frame 22. Subsequently, as illustrated in FIG. 6B, the large diameter hole 21j of the engaging hole 21h moves toward the head 24a of the clip 24, and the engaging hole 21h is in a state of being easily detached from the clip 24.

As the crushing of the front side frames 11 progresses, the cross member 23 that supports the trunk-side inclined surface 21f of the front trunk 21 approaches a back surface of the frame-shaped structural body 14. As illustrated in FIG. 6C, when the cross member 23 moves in a rear surface direction of the frame-shaped structural body 14, the support inclined surface 23a of the cross member 23 is inserted under the trunk-side inclined surface 21f of the front trunk 21. The front surface of the front trunk 21 abuts against the rear surface of the frame-shaped structural body 14. Therefore, as the cross member 23 is inserted, the front trunk 21 is raised upward along the rear surface of the frame-shaped structural body 14. When the cross member 23 is raised, the flange 21a on the front portion of the front trunk 21 is separated from the bracket 25. At this time, the head 24a of the clip 24 comes off from the large diameter hole 21j. Alternatively, the head 24a is destroyed.

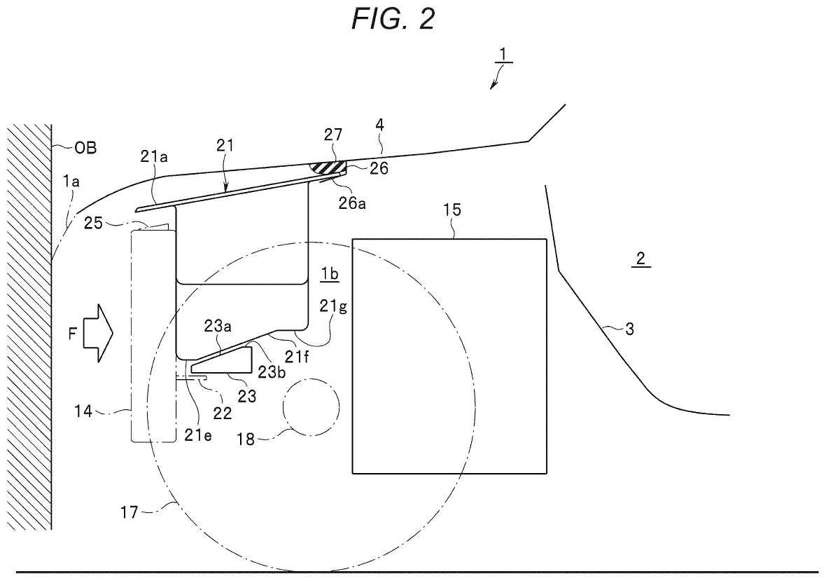

Further, as the tip ends of the front side frames 11 are crushed, a tip end of the front hood 4 also approaches the obstacle OB while being bent and deformed in a mountain folding direction. The claw 26a of the flange receiving member 26, which is fixed to the lower surface of the front hood 4, is inserted under the lower surface of the flange 21a on the rear portion of the front trunk 21. At this time, the flange 21a elastically deforms the elastic support member 27 and inserted over the claw 26a. Then, as illustrated in FIG. 2, the flange 21a on the rear portion is supported by being sandwiched between the claw 26a and the elastic support member 27.

When a tip end of the cross member 23 collides with the frame-shaped structural body 14, the impact load thereof is distributed to the left and right front side frames 11 via the cross member 23. Also, the impact load during the offset collision is distributed to the front side frames 11 on the non-collision side via the cross member 23. Therefore, the cross member 23 does not hinder the energy absorber (EA) characteristics of the vehicle body front portion 1.

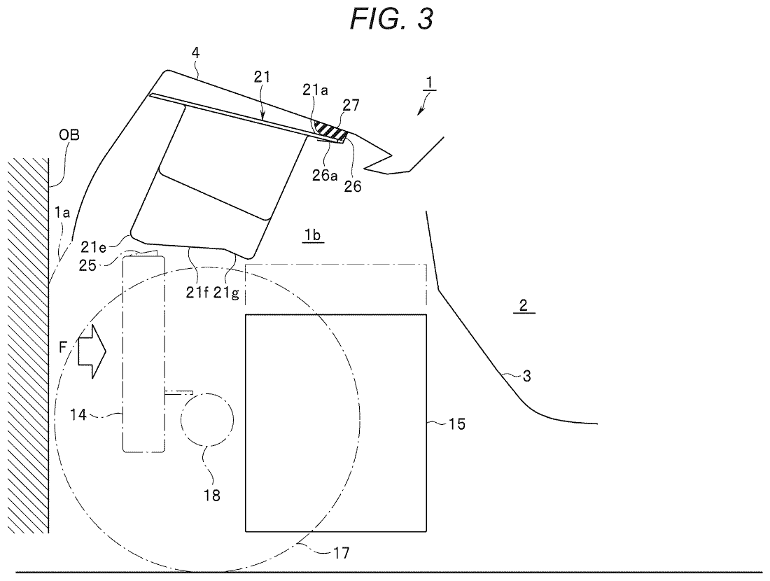

When the front side frames 11 are further crushed, as illustrated in FIG. 3, the front hood 4 is greatly bent and deformed in the mountain folding direction. Then, the front trunk 21, with the flange 21a held between the claw 26a of the flange receiving member 26 and the elastic support member 27, rises together with the front hood 4. The front trunk 21 is pulled up from the front space 1b between the frame-shaped structural body 14 and the high-voltage component 15.

Also, at this time, the entire vehicle body on the rear side, including the drive shaft 18, moves forward due to the crushing of the front side frames 11. This movement narrows the front space 1b between the frame-shaped structural body 14 and the high-voltage component 15, but the front trunk 21 is separated from the front space 1b. Therefore, a crushing stroke of the front side frames 11 is not hindered by the front trunk 21. Since the crushing stroke of the front side frame 11 is ensured, favorable energy absorber characteristics can be obtained.

In this manner, in the present embodiment, when the vehicle body front portion 1 is in a frontal collision, the front trunk 21 is pulled out from between the frame-shaped structural body 14 and the high-voltage component 15. Therefore, even in a state in which the contents are accommodated in the front trunk 21, the crushing stroke of the front side frames 11 is not hindered, and the impact load during the frontal collision can be efficiently absorbed.

Also, the front flat surface 21e of the lower surface of the front trunk 21 is placed on the support frame 22 that is fixed to the frame-shaped structural body 14. Further, the trunk-side inclined surface 21f and the rear flat surface 21g of the lower surface of the front trunk 21 are supported by the cross member 23. Further, the engaging hole 21h formed in the front flat surface 21e of the lower surface of the front trunk 21 is prevented from coming off by the clip 24 fixed to the support frame 22. Therefore, even in a state in which the contents are accommodated in the front trunk 21, the front trunk 21 can be stably supported.

It is noted that the disclosure is not limited to the above-described embodiment but may be applied, for example, to a rear-wheel drive vehicle in which the traveling motor 15a is disposed on a rear wheel side. Also, the disclosure may be applied to a four-wheel drive vehicle in which the traveling motor 15a is disposed on each of a front wheel side and a rear wheel side.

According to the disclosure, both ends of the cross member that comes into contact with the lower surface of the front trunk are fixed to the pair of the front side frames. A trunk-side inclined surface inclined upward and rearward from the front portion of the vehicle body is formed on the lower surface of the front trunk. A support inclined surface that comes into contact with the trunk-side inclined surface to support the front trunk is formed on the upper surface of the cross member. Therefore, when the vehicle body front portion collides with the obstacle, the support inclined surface of the cross member is inserted under the trunk-side inclined surface of the front trunk, and the front trunk is raised upward. The front trunk is pulled up from the front space, so that the crushing stroke of the front side frame can be ensured even in the state in which the contents are accommodated in the front trunk. As a result, the impact load during the frontal collision can be efficiently absorbed.

1. A vehicle body front structure for a vehicle, the vehicle body front structure comprising:
front side frames in a pair respectively disposed on left and right sides of a vehicle body front portion of the vehicle in a vehicle width direction of the vehicle;
a structural body having a rigidity disposed on a front side of the vehicle body front portion;
a high-voltage component disposed on a rear side of the vehicle body front portion; and
a front trunk attached to a front space between the structural body and the high-voltage component, wherein
both ends of a cross member are fixed to the front side frames respectively, the cross member extending on the left and right sides in the vehicle width direction and having an upper surface configured to come into contact with a lower surface of the front trunk,
a trunk-side inclined surface is provided on the lower surface of the front trunk, the trunk-side inclined surface being inclined upward from the vehicle body front portion to a rear portion of the vehicle, and
a support inclined surface is provided on the upper surface of the cross member, the support inclined surface being configured to come into contact with the trunk-side inclined surface to support the front trunk.

2. The vehicle body front structure according to claim 1, wherein
a flat surface is provided on a front portion of the lower surface of the front trunk,
a support frame extends from the structural body, the support frame being configured to come into contact with the flat surface, and
a locking member is fixed to the support frame, the locking member being configured to engage with an engaging hole in the flat surface to prevent the front trunk from coming off.

3. The vehicle body front structure according to claim 2, wherein
the locking member is a stepped member comprising a head and a body having a diameter smaller than a diameter of the head, the body being locked on the support frame, and
the engaging hole has a long hole into which the body is configured to be engaged such that the head prevents the long hole from coming off, and a large diameter portion provided at a rear portion of the long hole and continuous with the long hole, the large diameter portion having a diameter larger than the diameter of the head.

4. The vehicle body front structure according to claim 1, further comprising:
a front hood configured to open and close an upper portion of the vehicle body front portion, wherein
a flange is provided on at least a rear portion of an upper surface of the front trunk,
a flange receiving member is provided in the vehicle width direction on a lower surface of the front hood, the flange receiving member having a claw that is configured to be inserted under a lower surface of the flange when the vehicle body front portion collides with an obstacle, and
the claw is configured to, when the vehicle body front portion collides with an obstacle, pull the flange upward as the front hood bends and deform.

5. The vehicle body front structure according to claim 4, wherein
an elastic support member is provided at a position facing the claw of the front hood, the elastic support member being configured to press an upper surface of the flange when the claw is inserted under the lower surface of the flange.
